(19) United States
(12) Patent Application Publication
(10) Pub. No.: US 2009/0114109 A1
(43) Pub. Date: May 7, 2009

(54) Stamped and molded igniter body for airbag inflators

(75) Inventors: Doug Overton, Knoxville, TN (US); Tim Ellison, Knoxville, TN (US); Robert Zimbrich, Knoxville, TN (US); Barbara Shook, Knoxville, TN (US)

Correspondence Address: NIXON & VANDERHYE, PC, 901 NORTH GLEBE ROAD, 11TH FLOOR, ARLINGTON, VA, 22203, US

(73) Assignee: ARC AUTOMOTIVE INC., Knoxville, TN (US)

(21) Appl. No.: 11/979,298

(22) Filed: Nov. 1, 2007

(51) Int. Cl. C06C 5/06; B60R 21/26

(52) U.S. Cl. 102/200; 280/741

(57) ABSTRACT

An igniter body for an airbag inflator comprising a stamped metal body portion having a generally annular flange and a central opening. A generally cylindrical plastic connector portion is disposed within the annular flange and is connected to the body portion. The connector portion may be integrally molded within the body portion. The central opening in the body portion is constructed to receive an initiator therein, and the connector portion is constructed to receive a power module therein for connection to an initiator disposed in the central opening and surrounded by a sleeve that is secured to the body portion to retain the initiator thereon.

### CROSS-REFERENCES TO RELATED APPLICATIONS

N/A

### STATEMENT REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to an igniter body for an airbag inflator and, more particularly, to a stamped igniter body having a connector portion formed of plastic that is molded or otherwise connected to the stamped igniter body.

2. Description of the Background Art

One of the major challenges in hybrid airbag inflator construction is the reduction or elimination of potential gas leaks through the materials selected for the inflator and its components. There are a number of materials and processes that have been developed to reduce the gas leakage risk. Unfortunately, owing to the precise requirements for connection to the OEM control module, the igniter housing in many inflator constructions has been machined and thus is subject to gas leakage.

In attempts to reduce parts and process costs, some inflator constructions have been developed to combine the initiator, igniter body and connector features via the use of a separate igniter/initiator assembly which is then crimped into a separate housing that is attached to the inflator body. The necessity for the separate housing adds to the cost and complexity of the inflator construction.

The new and improved stamped and molded igniter body of the present invention is not subject to the above-described disadvantages.

### BRIEF SUMMARY OF THE INVENTION

The igniter body of the present invention comprises a stamped body portion formed of a suitable metal and a plastic connector portion integrally molded or otherwise connected to the body portion. The stamped body portion creates a material grain flow or grain structure modification to reduce or eliminate gas leaks therethrough when used in a hybrid airbag inflator construction. The stamped body portion does not require any secondary processing such as machining or milling, and may be provided with raised areas or other retention features for retaining the plastic connector portion in place when it is integrally molded thereto. In a modified embodiment, the plastic connector portion may be separately molded and connected to the stamped body portion by a snap-fit connection or other suitable connection. The plastic connector portion may be provided with shaped orientation features for insuring the proper connection of a plug or power module thereto.

An initiator is positioned within the stamped body portion and is secured in place thereon by a sleeve that encloses the initiator and is welded or otherwise connected to the body portion on the side thereof opposite to that of the connector portion. The assembled initiator and igniter body may then be positioned within the open end of a hybrid inflator housing and connected thereto by welding or the like, thereby eliminating the need for a separate igniter housing currently used in many inflator constructions. The connector portion may be provided with a 360° undercut to enable it to receive connector modules of different constructions.

### BRIEF DESCRIPTION OF THE DRAWINGS

FIG. 1 is a perspective view of a first embodiment of an igniter body constructed in accordance with the principles of the present invention:

FIG. 2 is a side elevational view in section of the igniter body shown in FIG. 1;

FIG. 3 is a perspective view of a second embodiment of an igniter body constructed in accordance with the principles of the present invention;

FIG. 4 is side elevational view of the igniter body of FIGS. 1 and 2 with an assembled initiator connected to the open end of a hybrid inflator housing;

FIG. 5 is a perspective view of a third embodiment of an igniter body constructed in accordance with the principles of the present invention; and

FIG. 6 is a side elevational view in section of the igniter body shown in FIG. 5.

### DETAILED DESCRIPTION OF THE INVENTION

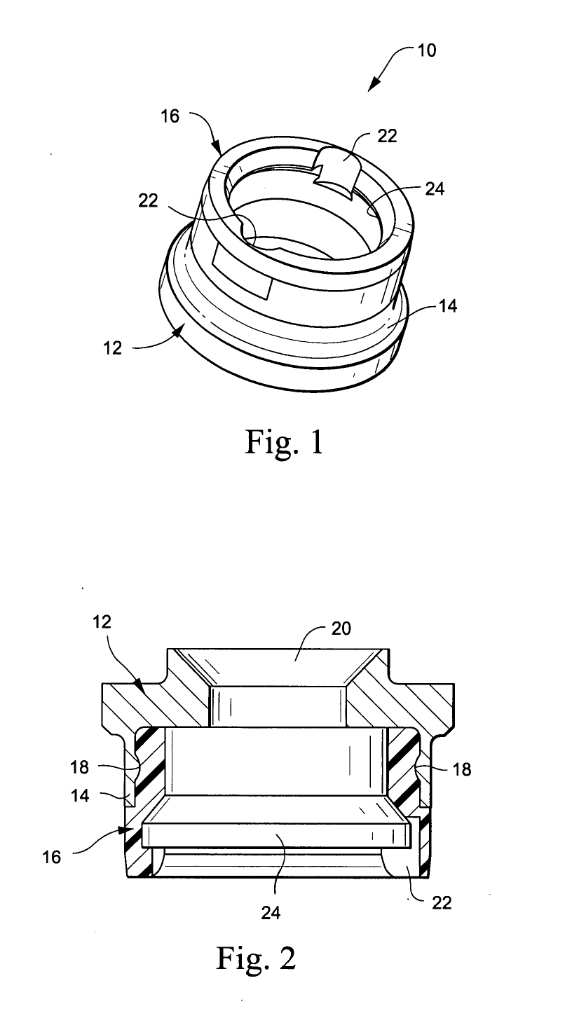

FIGS. 1 and 2 disclose a first embodiment of an igniter body 10 constructed in accordance with the principles of the present invention. The igniter body 10 comprises a stamped metal body portion 12 having a generally annular flange 14 surrounding the inner portion of a plastic connector portion 16 that is integrally molded thereto. The flange 14 may be provided with one or more inwardly extending or raised areas or barbs 18 to aid in retaining the molded connector portion 16 therein.

The body portion 12 comprises a central opening 20 for receiving an initiator (not shown). The opening 20 may be outwardly tapered to match the shape of the adjacent portion of the initiator to be positioned therein.

The connector portion 16 may comprise one or more recesses 22 that open into a 360° inner recess or undercut 24 for receiving a power or connector module (not shown) for the initiator (not shown).

Since the body portion 12 is stamped to modify grain structure, gas leaks therethrough are significantly reduced or eliminated. The body portion 12 may be formed of any suitable metal, such as low carbon steel or high strength alloy steels. The connector portion 16 may be formed of any suitable plastic, depending upon the environment to which it will be subjected, such as Nylon, PPS or a polamide. Because the connector portion 16 is molded, it can be provided with any suitable orientation features other than the recesses 22 for positioning a power or connector module therein. Also, the molded connector portion 16 offers protection from metal slivers or the like which can be introduced inadvertently during assembly to the module and thus will protect against insulation resistance issues.

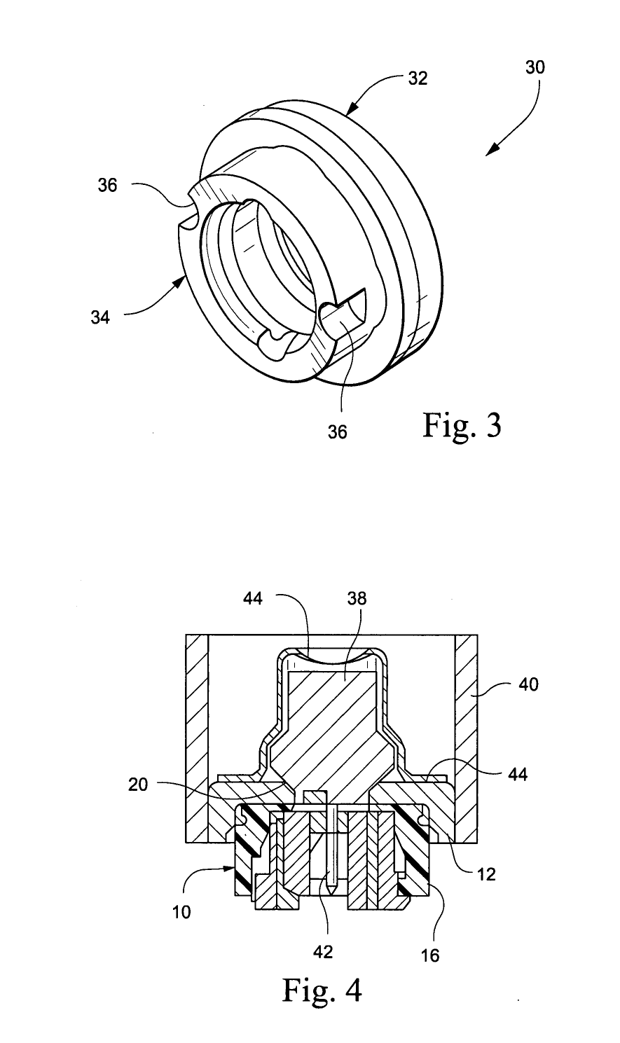

FIG. 3 discloses an igniter body 30 like the igniter body 10 in FIG. 1 which comprises a stamped body portion 32 and a connector portion 34 integrally molded therein. The molded connector portion 34 comprises one or more recesses 36 or the like on the outer surface thereof to mate with adjacent portions of a connector or power module (not shown) to prevent the rotation thereof when it is positioned therein.

FIG. 4 discloses the igniter body 10 of FIGS. 1 and 2 connected to an initiator 38 and assembled with the housing 40 of a hybrid airbag inflator intended to have a gas under pressure therein. The igniter body 10 comprises the stamped metal body portion 12 and the molded plastic connector portion 16. The initiator 38 is positioned within the opening 20 in the stamped body portion 12 and comprises connectors 42 to be coupled to a connector or power module (not shown) to be inserted in the connector portion 16. The initiator 38 is retained on the body portion 12 by a metal sleeve 44 that surrounds it and is connected to the adjacent outer surface of the body portion 12 by welding or the like. The stamped body portion 12 is secured to the adjacent inner surface of the inflator housing 40 in any suitable manner, such as by welding.

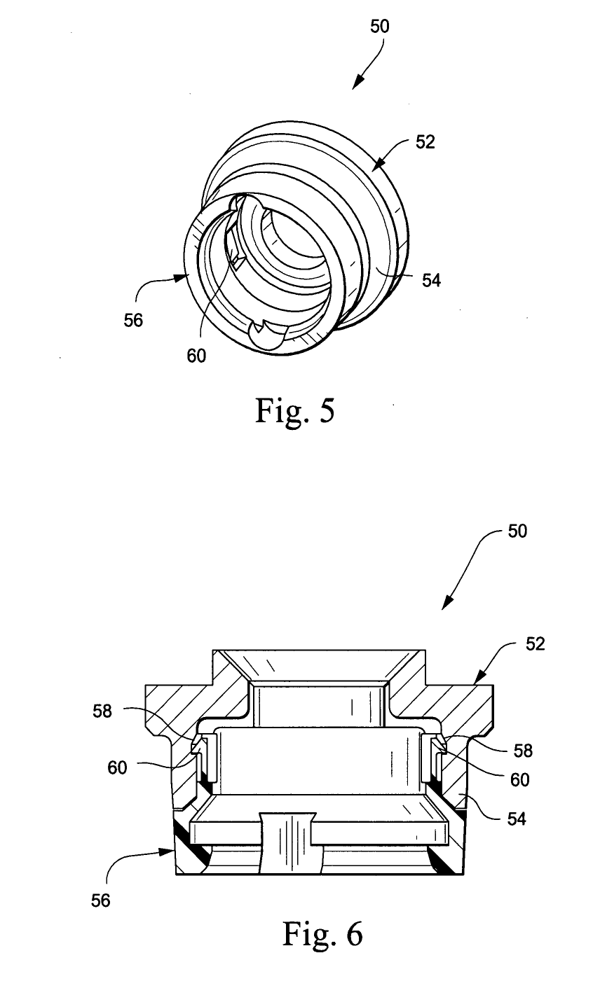

FIGS. 5 and 6 illustrate a third embodiment of an igniter body 50 constructed in accordance with the principles of the present invention. The igniter body 50 comprises a stamped metal body portion 52 having an annular flange 54 and a molded connector portion 56 having an inner end inserted within the annular flange 54 and connected thereto in any suitable manner. As an illustrative example, the annular flange 54 may be provided with a recess 58 in the inner surface thereof, and the inner end of the connector portion 56 may be provided with a plurality of flexible tabs or detents 60 that can be snap-fitted with the recess 58 to connect the molded plastic connector portion 56 to the stamped metal body portion 52.

From the foregoing description, it will be readily seen that the igniter bodies 10, 30 and 50 of the present invention are simple in construction, easy to manufacture and assemble, and also easily to connect to the hybrid inflator housing after an initiator has been secured thereto. Also, the molded plastic connector portion of each igniter body can be easily constructed to provide for the connection and orientation of a power or connector module and also to prevent rotation of the module once it is connected to the molded plastic connector portion and to the initiator. The new and improved igniter bodies of the present invention eliminate the need for a separate initiator housing used in many airbag inflators at the present time.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. An igniter body for an airbag inflator, comprising:
a stamped metal body portion having a generally annular flange and a central opening; and
a generally cylindrical plastic connector portion disposed within said annular flange and connected to said body portion;
said central opening in said body portion having constructed to receive an initiator therein; and
said connector portion being constructed to receive a power module therein for connection to an initiator disposed in said central opening.

2. The igniter body of claim 1 wherein said connector portion is integrally molded within said body portion.

3. The igniter body of claim 2 wherein said annular flange comprises inwardly extending areas for anchoring and retaining said connector portion within said body portion.

4. The igniter body of claim 1 wherein said connector portion is connected to said body portion by a snap-fit connection.

5. The igniter body of claim 4 wherein said annular flange has an internal recess, and said connector portion has a tab that is snap-fitted into said internal recess.

6. The igniter body of claim 1 wherein said connector portion has a recessed area on an inner surface thereof, and a 360° annular undercut on said inner surface in communication with said recessed area for receiving a complementary portion of a power module therein.

7. The igniter body of claim 6 wherein an outer surface of said connector portion is constructed to prevent rotation of a power module positioned in said connector portion.

8. The igniter body of claim 7 wherein said outer surface of said connector portion has a recess for receiving therein a complementary portion of a power module therein to prevent rotation thereof.

9. The igniter body of claim 1 further comprising an initiator disposed in said central opening, and a sleeve surrounding said initiator and secured to an adjacent portion of said body portion.

10. The igniter body of claim 9 wherein said sleeve is metal and is welded to said body portion.

11. The igniter body of claim 9 wherein said initiator has a plug extending into said connector portion for connection to a power module when it is positioned in said connector portion.

12. A hybrid inflator for an airbag comprising:
an inflator housing having an open end; and
an igniter body secured to the open end of said inflator housing;
said igniter body comprising a stamped metal body portion having a generally annular flange and a central opening, and a generally cylindrical plastic connector portion disposed within said annular flange and connected to said body portion;
an initiator disposed in said central opening, and a sleeve surrounding said initiator and secured to an adjacent portion of said body portion;
said metal body portion being secured to an adjacent portion of said inflator housing.

13. The hybrid inflator of claim 12 wherein said connector portion is integrally molded within said body portion.

14. The hybrid inflator of claim 12 wherein said connector portion is connected to said body portion by a snap-fit connection.

15. The hybrid inflator of claim 12 wherein said sleeve is metal and is welded to said body portion.

16. The hybrid inflator of claim 12 wherein said initiator has a plug extending into said connector portion for connection to a power module when it is positioned in said connector portion.
